(19) United States
(12) Patent Application Publication
(10) Pub. No.: US 2008/0295650 A1
(43) Pub. Date: Dec. 4, 2008

(54) HAND TOOL WITH BIT RELEASE DEVICE

(76) Inventor: CHIH-CHING HSIEH, Taichung Hsein (TW)

Correspondence Address: BENJAMIN SU, P.O. BOX 70-121 TAICHUNG, TAICHUNG CITY, 48099, TW

(21) Appl. No.: 12/124,169

(22) Filed: May 21, 2008

Related U.S. Application Data
(62) Division of application No. 11/802,939, filed on May 29, 2007.

(51) Int. Cl. B25B 23/16; B25B 13/06

(52) U.S. Cl. 81/177.85; 81/121.1

(57) ABSTRACT

A hand tool includes a socket which is connected to a head of the hand tool and the socket includes first and second recesses in tow ends thereof and a passage is defined in communication between the first and second recesses. A push rod includes a head and a shank which extends through the first recess, the passage and is inserted in the second recess in which a bit is inserted. A spring is mounted to the shank and biased between the head and an inner end of the first recess. The screw bit can be quickly pushed out from the second recess of the socket by pushing the push rod toward the screw bit.

### CROSS-REFERENCE TO RELATED APPLICATION

This application is a Divisional application of Ser. No. 11/802,939, filed 29 May 2007, and entitled “HAND TOOL WITH BIT RELEASE DEVICE”, now pending.

### BACKGROUND OF THE INVENTION

1. Field of the Invention

The present invention relates to a hand tool with a bit quick release device which allows the user to replace bits conveniently.

2. Description of Related Art

A conventional screw bit socket assembly is disclosed in FIG. 17, and generally includes a cruciform tube 30 and a positioning bead extends inward from an inner periphery of the passage of each ends of the tube 30. A screw bit 40 has one end inserted into the passage and includes a notch defined in an outer periphery thereof so that the bead 31 is engaged with the notch to position the screw bit 40 in the passage. When the screw bit 40 is to be removed from the passage, the user has to hold the screw bit 40 and pull the screw bit 40 in its longitudinal direction out from the tube 30. The screw bit 40 has a small diameter and the bead 31 is securely engaged with the notch, so that it is difficult to easily pull the screw bit 40 out from the passage, especially when the user's hand is attached with grease or oil. Another shortcoming is that the pulling force is applied in longitudinal direction of the screw bit 40 and this direction is perpendicular to the direction that the user holds the screw bit 40, the two perpendicular force are not related to each other.

The present invention intends to provide a hand tool with a quick release device which includes a push rod which is easily to be pushed toward the screw bit which is easily pushed to disengage from the socket.

### SUMMARY OF THE INVENTION

The present invention relates to a hand tool which comprises a handle with a head which includes an engaging hole in which a plurality of parallel first grooves and first ridges are defined. A socket has a first recess and a second recess in two ends thereof. A connection portion is defined in a portion of an outer periphery of the socket and includes second grooves and second ridges so as to be engaged with the first ridges and grooves in the head of the hand tool. A passage is in communication between the first and second recesses. A bead is engaged with an aperture defined through a wall of the socket and a recessed area defined in the outer periphery of the socket. A flexible plate is engaged with the recessed area and includes a restriction hole which is located corresponding to the bead. A quick release device includes push rod which includes a head and a shank, and a spring is mounted to the shank which is inserted in the first recess and extends through the passage. The spring is biased between the head and an inner end of the first recess. A push member is connected to a distal end of the shank and located in the second recess. The bit is pushed out from the second recess of the socket by pushing the push rod toward the bit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the socket assembly and the quick release device to be used with the hand tool of the present invention;

FIG. 2 is a cross sectional view to show the socket assembly and the quick release device of the present invention;

FIG. 3 shows the hand tool and the socket assembly and the quick release device of the present invention;

FIG. 4 shows that a user holds the handle of the hand tool to drive a bit connected to the socket assembly of the present invention;

FIG. 5 is a cross sectional view to show that a bit is connected to the socket assembly of the present invention;

FIG. 6 shows that the bit is pushed out from the second recess of the socket by pushing the push rod;

FIG. 7 is an exploded view to show a second embodiment of the socket assembly and the quick release device of the present invention;

FIG. 8 is a cross sectional view to show the socket assembly and the quick release device of the present invention in FIG. 7;

FIG. 9 is a cross sectional view to show that the bit is connected to the socket assembly in FIG. 7 of the present invention;

FIG. 10 shows that the bit is pushed out from the second recess of the socket in FIG. 7 by pushing the push rod;

FIG. 11 is an exploded view of a third embodiment of the socket assembly and the quick release device to be used with the hand tool of the present invention;

FIG. 12 is a cross sectional view to show that a bit is connected to the socket assembly in FIG. 11 of the present invention;

FIG. 13 shows that the bit is pushed out from the second recess of the socket assembly in FIG. 11 by pushing the push rod;

FIG. 14 is an exploded view of a fourth embodiment of the socket assembly and the quick release device to be used with the hand tool of the present invention;

FIG. 15 is a cross sectional view to show that a bit is connected to the socket assembly in FIG. 14 of the present invention;

FIG. 16 shows that the bit is pushed out from the second recess of the socket in FIG. 14 by pushing the push rod; and

FIG. 17 shows a conventional screw bit socket assembly.

### DETAILED DESCRIPTION OF THE INVENTION

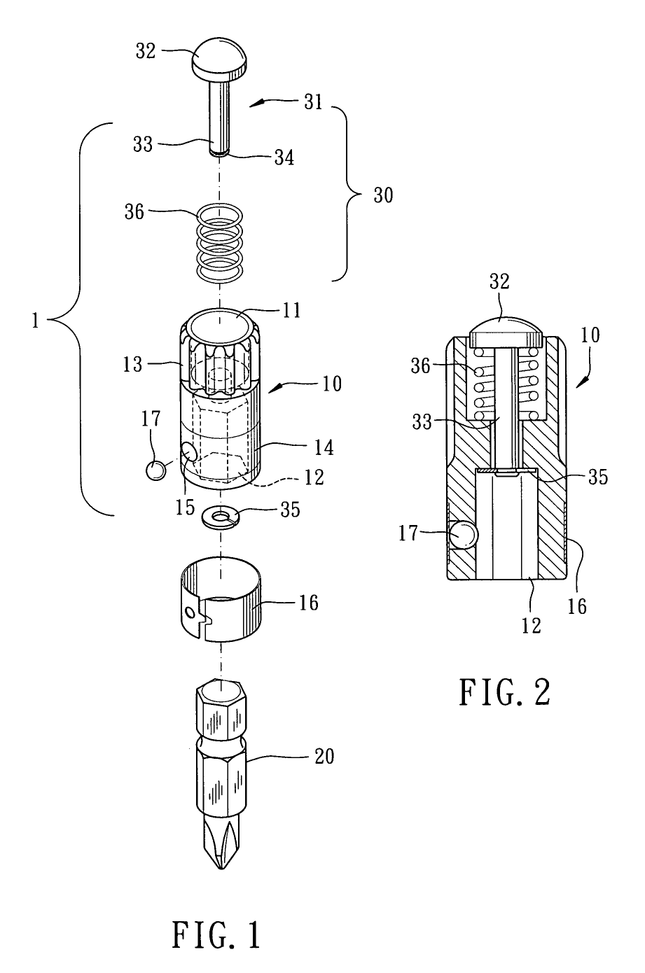

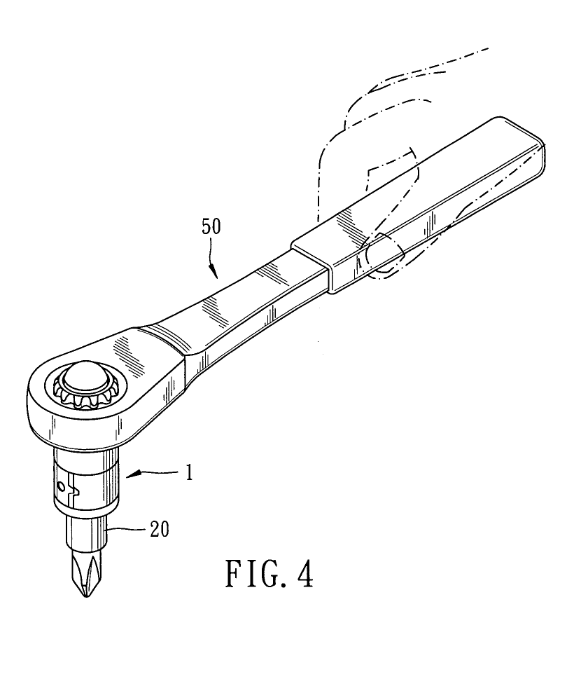

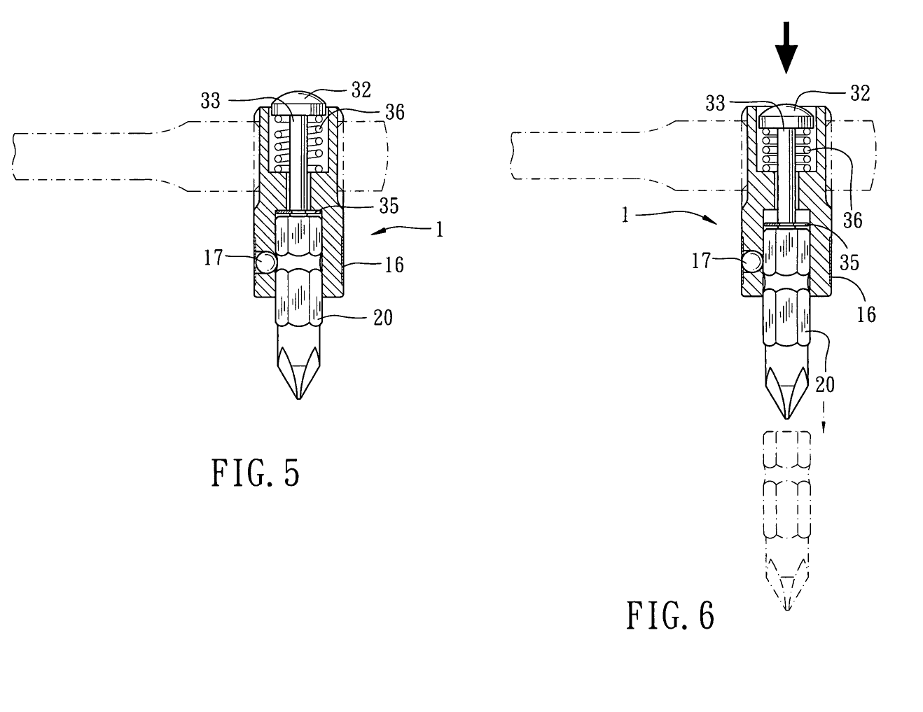

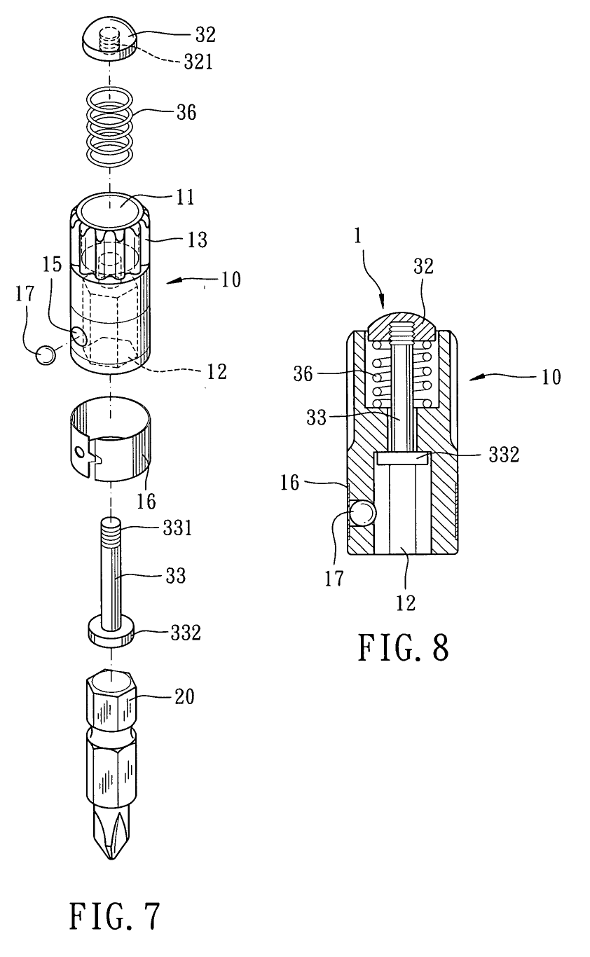

Referring to FIGS. 1 to 6, a hand tool 50 comprises a handle with a head connected to an end thereof and the head includes an engaging hole 51 which includes a plurality of first grooves and first ridges which are parallel to the first grooves. A socket assembly 1 includes a socket 10 which has a first recess 11 and a second recess 12 defined in a first end and a second end of the socket respectively. A connection portion 13 is defined in a portion of an outer periphery of the socket 10 and a plurality of second grooves and second ridges are defined axially in the connection portion 13. The second ridges are parallel to the second grooves. The connection portion 13 is inserted into the through hole 51 and the first ridges are engaged with the second grooves and the second ridges are engaged with the first grooves. Therefore, when rotating the hand tool 50, the socket 10 is rotated with the hand tool 50. A passage is defined in communication between the first and second recesses 11, 12. An aperture 15 is defined through a wall of the socket 10 and communicates with the second recess 12. A bead 17 is engaged with the aperture 15. A recessed area 14 is defined in the outer periphery of the socket 10 and communicated with the aperture 15. A flexible plate 16 is engaged with the recessed area 14 and includes a restriction hole defined therethrough. The restriction hole is located corresponding to the bead 17, and a diameter of the bead 17 is larger than a diameter of the restriction hole in the flexible plate 16 so that the bead 17 does not drop from the restriction hole.

A quick release device 30 includes a push rod 31 including a head 32 and a shank 33 which is perpendicularly and integrally connected to the head 32. A spring 36 is mounted to the shank 33 which is inserted in the first recess 11 and extends through the passage. The spring 36 is biased between the head 32 and an inner end of the first recess 11. An engaging groove 34 is defined in an outer periphery of the distal end of the shank 33 and a push member 35 is securely engaged with the engaging groove 34. The push member 35 is located in the second recess 12.

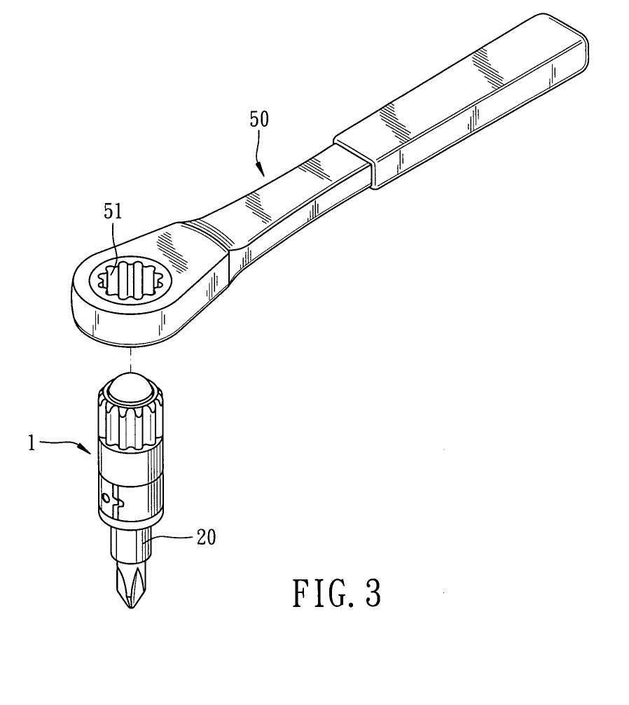

A bit 20 is inserted into the second recess 12 of the socket 10 and includes a groove with which the bead 17 is engaged so as to position the bit 20 in the second recess 12 of the socket 10. As shown in FIGS. 3 to 5, the user holds the handle and rotates the hand tool 50 so that the bit 20 is rotated so as to tighten or loosen a screw (not shown) for example.

When the user wants to remove the bit 20 out from the second recess 12 of the socket 10, he/she simply pushes the head 32 toward the bit 20, the push member 35 together with the shank 33 is moved to push the bit 20 so that the groove of the bit 20 is disengaged from the bead 17 so that the bit 20 is easily pushed out from the second recess 12 of the socket 10.

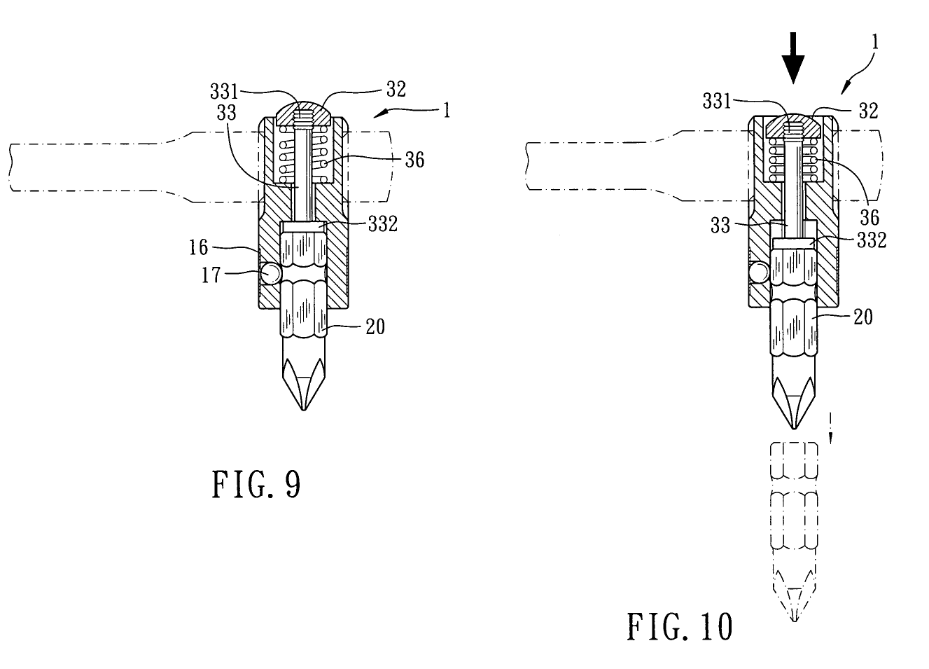

FIGS. 8 to 10 show a second embodiment of the quick release device 30, wherein the head 32 includes a threaded hole 321 defined in an underside thereof and the shank 33 includes a threaded section 331 which is threadedly connected to the threaded hole 321 in the head 32. The only difference between the second embodiment and the first embodiment is the direction that the shank 33 is assembled with the socket 10.

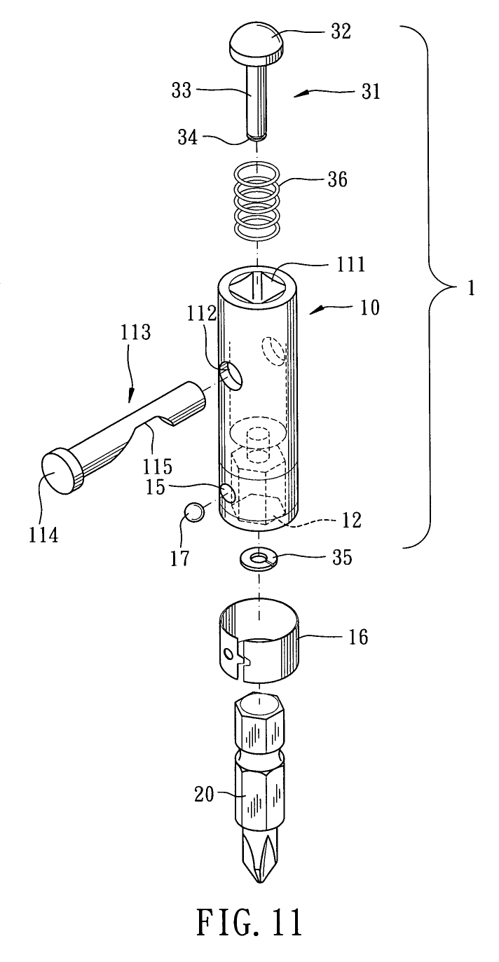

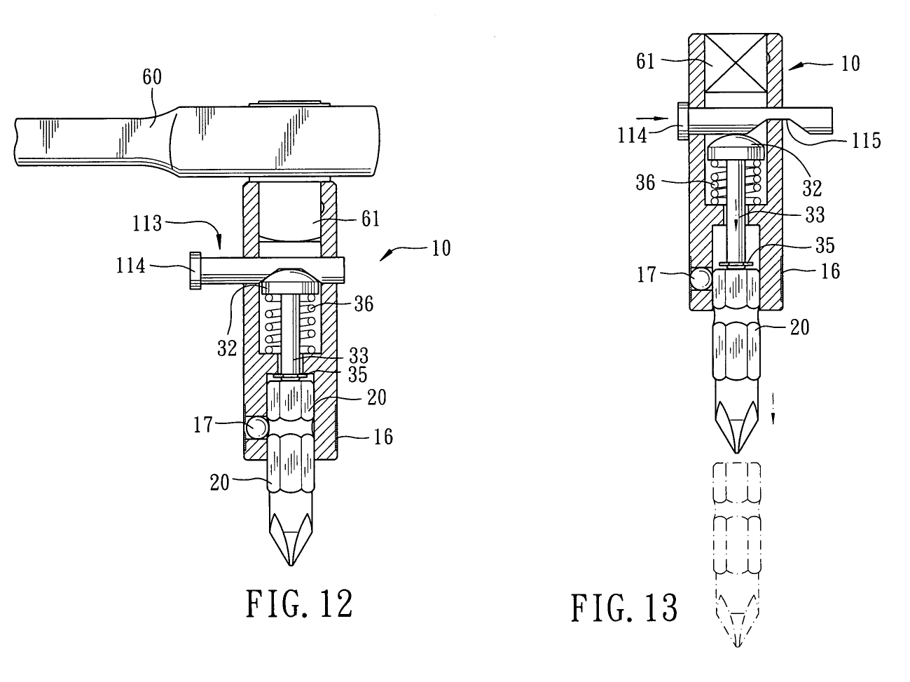

A third embodiment of the socket assembly 1 is shown FIGS. 11 to 13, wherein connection portion 13 is omitted and two aligned holes 112 are defined through a wall of the socket 10 and a push bar 113 transversely and movably extends through the aligned holes 112 of the socket 10. A reception recess 115 is defined radially in an outer surface of the push bar 113 and includes a tapered inner periphery. A stop 114 is connected to an end of the push bar 115 and a diameter of the stop 114 is larger than a diameter of each of the aligned holes 112 so that the push bar 113 does not drop from the socket 10 when pushing the transverse bar 113. The head 32 of the push rod 31 is engaged with the reception recess 115 so that when pushing the transverse bar 113, the push rod 31 is pushed toward the second recess 12 by the tapered inner periphery of the reception recess 115.

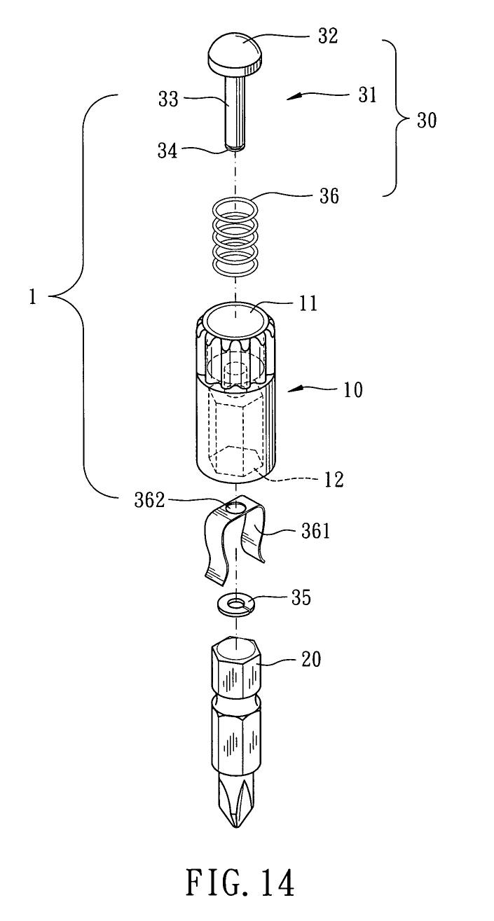

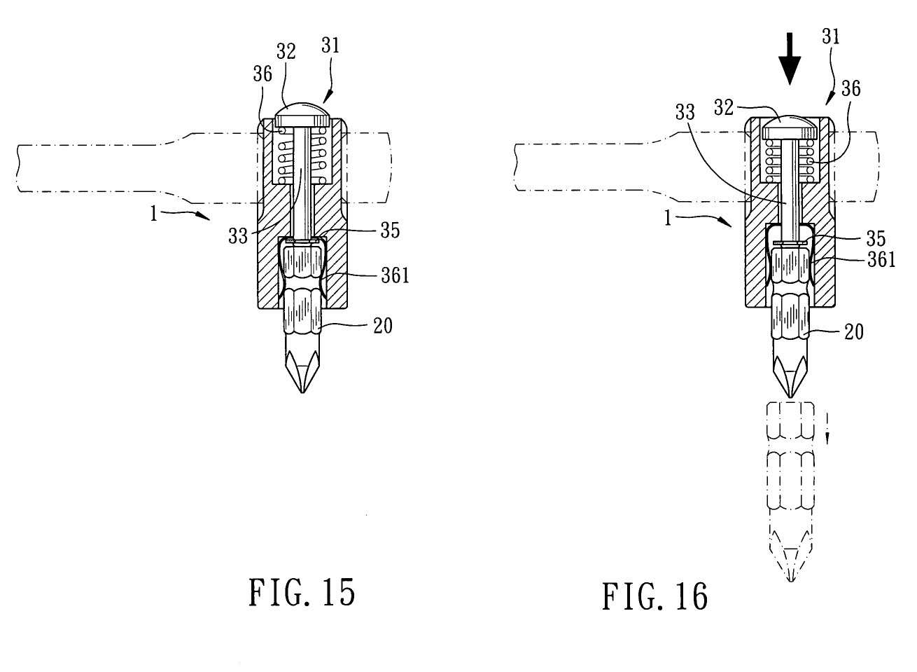

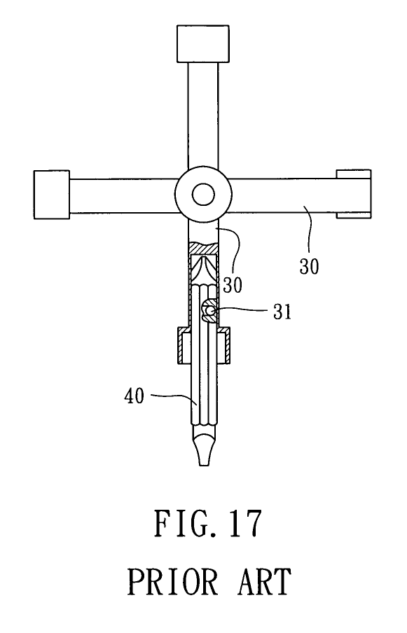

A fourth embodiment of the socket assembly 1 is shown in FIGS. 14 to 16, wherein the aperture 15, the flexible plate 16 and the bead 17 in the first embodiment are omitted, and a U-shaped holding member is received in the second recess 12 so as to hold the bit 20. The U-shaped holding member includes a transverse section and two flexible legs 361 which extend from two ends of the transverse section and are engaged with the inner periphery of the second recess 122 by their outward tension. Each flexible leg 361 includes a curved section and a distance between the two curved sections being smaller than a distance between the two flexible legs 361, so that the two curved sections of the two flexible legs 361 are engaged with the groove in the bit 20 which is then positioned in the second recess 12. a distal end of the shank 33 extends through a central hole 362 defined through the transverse section of the U-shaped holding member, and the push member 35 connected to the distal end of the shank 33 and located beneath the transverse section of the U-shaped holding member. By the spring 36 mounted to the shank 33, the transverse section of the U-shaped holding member is clamped between the inner end of the second recess 12 and the push member 35. The bit 20 is easily pushed out from the second recess 12 of the socket 10 by pushing the push rod 31 as described in the first embodiment.

While we have shown and described the embodiment in accordance with the present invention, it should be clear to those skilled in the art that further embodiments may be made without departing from the scope of the present invention.

What is claimed is:

1. A hand tool comprising:
a handle with a head connected to an end thereof and the head including an engaging hole which includes a plurality of first grooves and first ridges which are parallel to the first grooves;
a socket assembly including a socket having a first recess defined in a first end thereof and a connection portion defined in a portion of an outer periphery of the socket, a plurality of second grooves and second ridges defined axially in the connection portion, the second ridges being parallel to the second grooves, the connection portion inserted into the through hole and the first ridges engaged with the second grooves and the second ridges engaged with the first grooves, a second recess defined in a second end of the socket and a passage being in communication between the first and second recesses, an aperture defined through a wall of the socket and communicating with the second recess, a bead engaged with the aperture, a recessed area defined in the outer periphery of the socket and communicating with the aperture, a flexible plate engaged with the recessed area and including a restriction hole defined therethrough, the restriction hole located corresponding to the bead, a diameter of the bead being larger than a diameter of the restriction hole in the flexible plate; and
a quick release device including a push rod including a head and a shank which is perpendicularly connected to the head, a spring mounted to the shank which is inserted in the first recess and extends through the passage, the spring biased between the head and an inner end of the first recess, a push member connected to a distal end of the shank and located in the second recess.

2. The hand tool as claimed in claim 1, wherein the head includes a threaded hole defined in an underside thereof the shank includes a threaded section which is threadedly connected to the threaded hole in the head.
